(19) United States
(12) Patent Application Publication
(10) Pub. No.: US 2013/0086955 A1
(43) Pub. Date: Apr. 11, 2013

(54) LOCK INTERFACE SYSTEM AND METHOD

(71) Applicant: Jay S. Derman, Palos Verdes Peninsula, CA (US)

(72) Inventor: Jay S. Derman, Palos Verdes Peninsula, CA (US)

(21) Appl. No.: 13/270,439

(22) Filed: Oct. 11, 2011

(51) Int. Cl. E05B 73/00; E05B 67/22

(52) U.S. Cl. 70/15; 70/53

(57) ABSTRACT

A system for securing an item to an anchor is disclosed. The system may include an anchor, an item having an extension extending therefrom, an interface mechanism, a padlock, and a tether. The interface mechanism may received and engage the extension therewith. The padlock may selectively engage the interface mechanism in a manner to prevent the interface mechanism from releasing the extension. The tether may extend to tie the padlock to the anchor and, thereby, secure, the item to the anchor.

### BACKGROUND

1. The Field of the Invention

This invention relates to security systems and, more particularly, to novel systems and methods for tethering personal property to an anchor.

2. The Background Art

As computers, expensive electronic equipment, and other valuable portable articles have become more common, theft of such articles has increased. There are a number of different devices on the market to deter such theft. However, most of these devices are either bulky, so that they are not particularly portable, or they relay on specially designed locks. Accordingly, what is needed is an improved system and method for securing valuable portable articles that supports the use of conventional locks.

### BRIEF SUMMARY OF THE INVENTION

In view of the foregoing, in accordance with the invention as embodied and broadly described herein, a method and apparatus are disclosed in one embodiment of the present invention as including a system protecting an item from theft or unwanted removal. In selected embodiments, a system may include a lock, an anchor, and an interface mechanism. An interface mechanism may be connected to an extension extending from an item (e.g., valuable portable article). A lock may selectively engage an interface mechanism and extend therefrom to engage an anchor, thereby forming a secure tie or link from the item to the anchor.

In selected embodiments, an interface mechanism may include a base and a slide. A base may include an extension aperture formed therein. An extension aperture may be sized and shaped to receive therewithin an extension (e.g., an anchor extending from the item to be secured). To selectively secure an extension within an extension aperture, an interface mechanism may include one or more interference members. An interference member may extend to engage an extension and, thereby, resist the removal of the extension from the interface mechanism.

In certain embodiments, a base may include one or more interference apertures. Each interference aperture may contain, or partially contain, a corresponding interference member. Each interference member may extend from a corresponding interference aperture to engage an extension.

A slide may be configured to travel with respect to a base. For example, a slide may be configured to translate in the axial direction with respect to a corresponding base. In selected embodiment, a slide may move between one or more blocking positions and one or more non-blocking positions. In a blocking position, a slide may block an interference member from moving out of engagement with an extension. Accordingly, when a slide is in a blocking position, an interface mechanism may be secured to a corresponding extension.

In a non-blocking position, a slide may permit an interference member to move within the corresponding interference aperture. Accordingly, with a slide in a non-blocking position, an interference member may move out of engagement with an extension. Accordingly, when a slide is in a non-blocking position, an interface mechanism may be easily removed from a corresponding extension.

In selected embodiments, an interface mechanism may include a shackle aperture. A shackle aperture may extend through a base, a slide, or some combination thereof. A shackle aperture may provide a location for a shackle of a lock to engage and secure to an interface mechanism. A shackle aperture may also enable a shackle to secure a slide with respect to a base in a blocking position. Accordingly, a shackle passing through a shackle aperture may enable a secure connection or link from an extension to an interface mechanism and from the interface mechanism to a lock corresponding to the shackle.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic diagram of one embodiment of a system for securing an item in accordance with the present invention;

FIG. 2 is a perspective view of one embodiment of an extension in accordance with the present invention;

FIG. 3 is a perspective view of one embodiment of an interface mechanism in accordance with the present invention;

FIG. 4 is a bottom view of the interface mechanism of FIG. 3;

FIG. 5 is a cross-sectional view of the interface mechanism of FIG. 3 engaging an extension in accordance with the present invention with the slide in a blocking position;

FIG. 6 is a cross-sectional view of the interface mechanism of FIG. 3 in an unlocked configuration in accordance with the present invention with the slide in a non-blocking position;

FIG. 7 is a cross-sectional view of an alternative embodiment of an interface mechanism in a locked configuration in accordance with the present invention with the slide in a blocking position;

FIG. 8 is a cross-sectional view of the interface mechanism of FIG. 7 in an unlocked configuration in accordance with the present invention with the slide in a non-blocking position;

FIG. 9 is a perspective view of another alternative embodiment of an interface mechanism in accordance with the present invention;

FIG. 10 is a cross-sectional view of the interface mechanism of FIG. 9 in a locked configuration in accordance with the present invention with the slide in a blocking position; and

FIG. 11 is a cross-sectional view of the interface mechanism of FIG. 9 in an unlocked configuration in accordance with the present invention with the slide in a non-blocking position.

### DETAILED DESCRIPTION OF SELECTED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

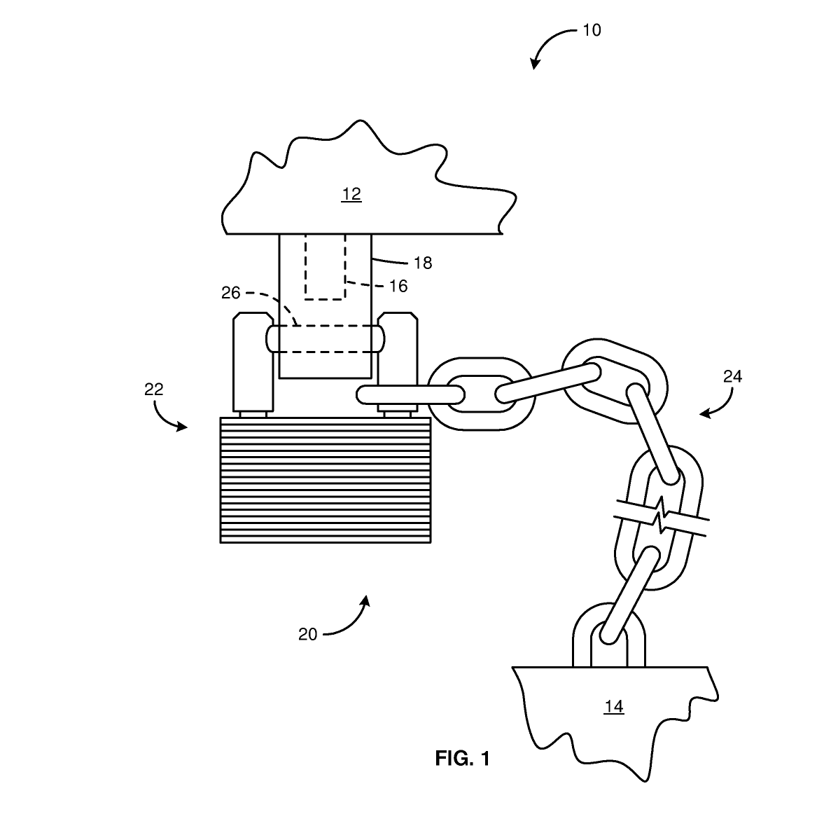

Referring to FIG. 1, a system 10 in accordance with the present invention may protect an item 12 (e.g., valuable portable article, laptop computer, digital music player, camera, or the like) from theft or unwanted removal. In selected embodiments, this may be done by tethering an item 12 to an anchor 14. An anchor 14 may be an object that is substantially fixed in place (e.g., an embedded post or the like). Alternatively an anchor 14 may be an object sufficiently heavy, bulky, or both to rendering moving the object unpractical or undesirable. For example, an anchor 14 may comprise a desk, table, or the like that may be moved or dismembered, but only with significant effort or with the generation of unwanted attention from surrounding individuals.

In selected embodiments, an item 12 may include an extension 16 extending therefrom. In such embodiments, a system 10 may include an interface mechanism 18 configured to receive and retain an extension 16. A lock 20 may selectively (e.g., releasably) engage an interface mechanism 18 and extend therefrom to engage an anchor 14. In certain embodiments, a lock 20 may include a locking mechanism 22 and a flexible tether 24.

A locking mechanism 22 may be configured to selectively engage an interface mechanism 18. A locking mechanism 22 may prevent an interface mechanism 18 from releasing a corresponding extension 16. In selected embodiments, a locking mechanism 22 may comprise a padlock having a shackle 26 (e.g., a straight or curved shackle 26). A flexible tether 24 may comprise chain, cable, or the like. In selected embodiments, a flexible tether 24 may secure to a locking mechanism 20 (e.g., engage or loop through or around a shackle 26) and extend therefrom to engage (e.g., loop through or around) an anchor 14.

The various components of a system 10 in accordance with the present invention may be formed of any suitable materials. Suitable materials may be selected to provide a desired durability, strength, rigidity, toughness, or the like. For example, in selected embodiments, one or more of the components of an interface mechanism 18 may be formed of a polymer material. However, in other embodiments where greater stresses are expected, such components may be formed of a metal or metal alloy.

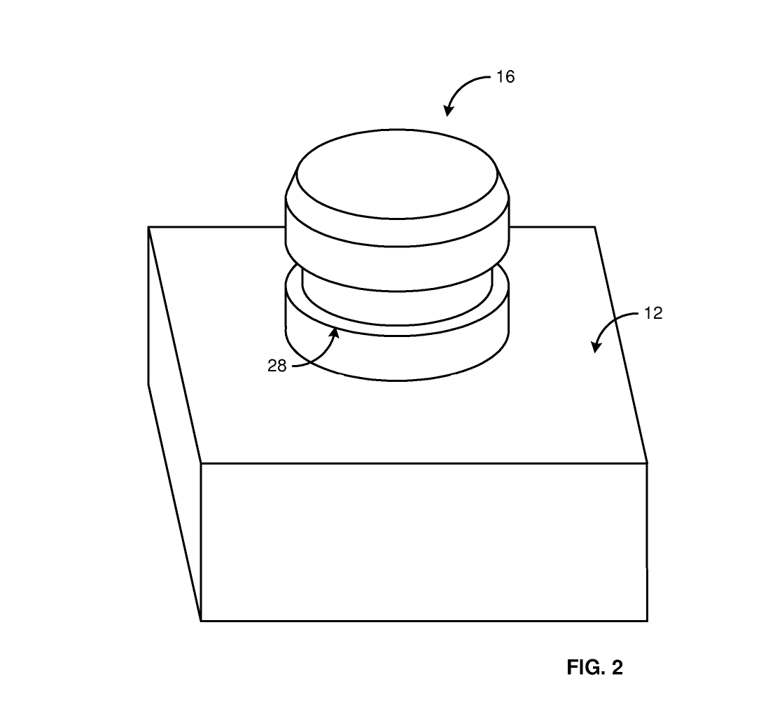

Referring to FIG. 2, an extension 16 in accordance with the present invention may have any suitable configuration. Similarly, an extension 16 may connect to, or extend from, an item 12 in any suitable manner. In certain embodiments, an extension 16 may be configured as an anchor disclosed in U.S. Pat. No. 6,081,974 issued Jul. 4, 2000, U.S. Pat. No. 6,317,936 issued Nov. 20, 2001, or U.S. Pat. No. 6,360,405 issued Mar. 26, 2002, each of which is hereby incorporated by reference. Alternatively, an extension 16 may be configured as an attachment device disclosed in U.S. Pat. No. 7,997,106 issued Aug. 16, 2011 or U.S. Pat. No. 8,001,812 issued Aug. 23, 2011, both of which are hereby incorporated by reference. In still other embodiments, an extension 16 may be configured as an interface mechanism disclosed in U.S. patent application Ser. No. 13/216,076 filed Aug. 23, 2011, which is hereby incorporated by reference.

In selected embodiments, an extension 16 may include one or more mechanisms or structures enabling an interface mechanism 18 to engage therewith. For example, an extension 16 may include a locking groove 28 enabling an interface mechanism 18 to selectively grip a corresponding extension 16. In certain embodiments, a locking groove 28 may extend circumferentially about an extension 16. Such a locking groove 28 may enable an interface mechanism 18 to pivot about the corresponding extension 16, while maintaining a secure engagement therewith.

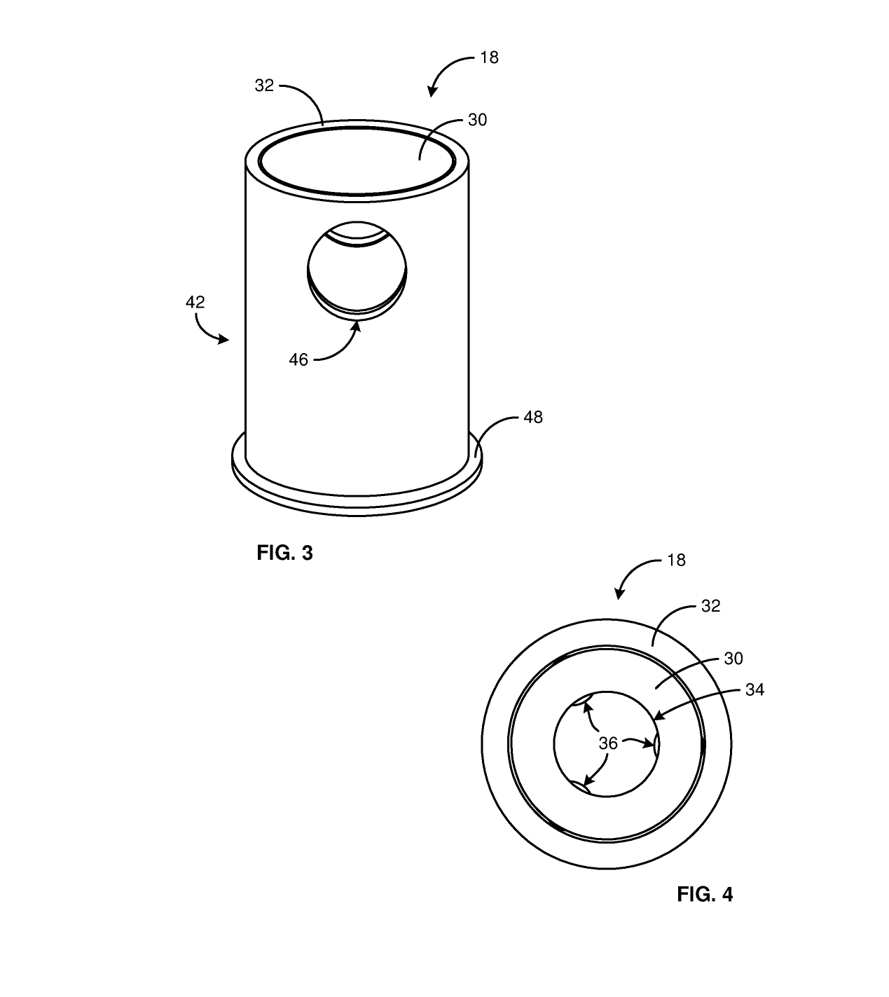

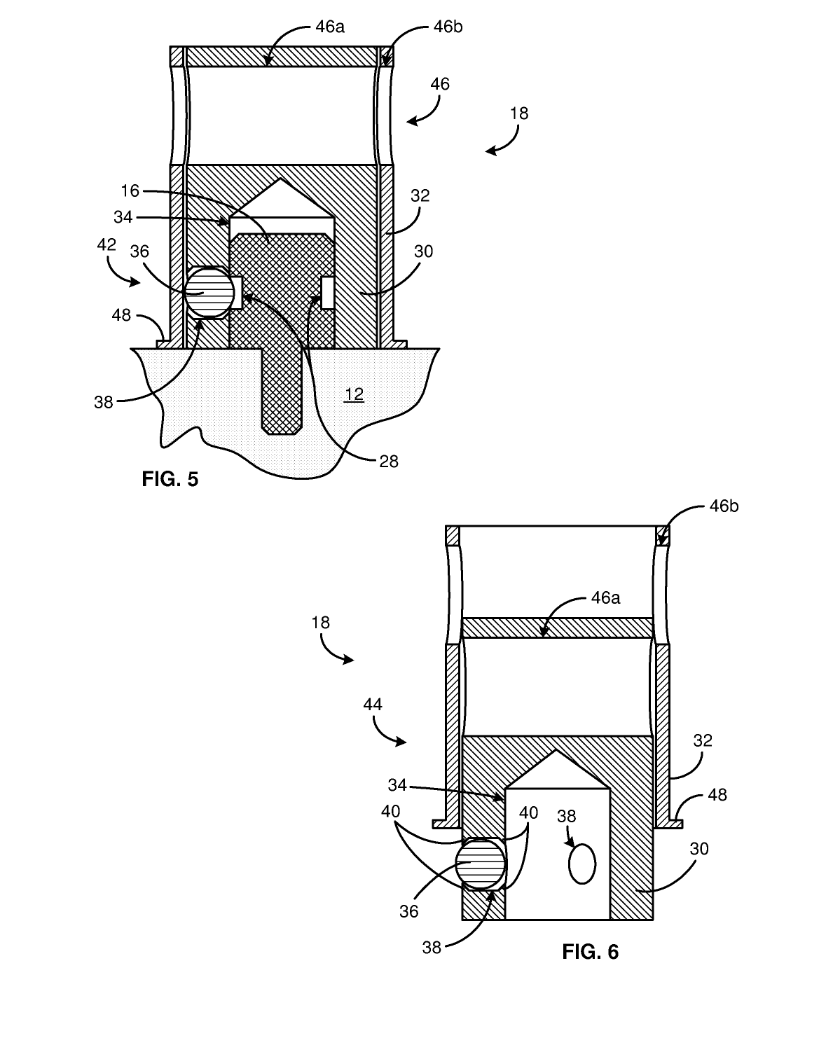

Referring to FIGS. 3-6, an interface mechanism 18 may include a base 30 and a slide 32. In selected embodiments, an interface mechanism 18 or portion thereof may have a cylindrical shape and define axial, radial, and circumferential directions. For example, a base 30 or portion thereof may have cylindrical shape. Accordingly, a base 30 may be referred to as a cylindrical base. Similarly, a slide 32 or portion thereof may have cylindrical shape. Accordingly, a slide 32 may be referred to as a cylindrical slide.

In certain embodiments, a base 30 may include an extension aperture 34 formed therein. An extension aperture 34 may be sized and shaped to receive an extension 16 therewithin. In selected embodiments, an extension 16 may be inserted in the axial direction within a base 30.

An interface mechanism 18 may selectively secure an extension 16 therewithin. Such securement may be accomplished in any suitable manner. In selected embodiments, an interface mechanism 18 may include one or more interference members 36. An interference member 36 may extend to engage an extension 16 and, thereby, resist the removal of the extension 16 from the interface mechanism 18.

In certain embodiments, a base 30 may include one or more interference apertures 38. Each interference aperture 38 may contain, or partially contain, a corresponding interference member 36. Each interference member 36 may extend from a corresponding interference aperture 38 to engage an extension 16. For example, each interference member 36 may extend from a corresponding interference aperture 38 into a locking groove 28 of an extension 16.

An interference member 36 may be maintained within an interference aperture 38 in any suitable manner. In selected embodiments, one or more constrictions 40 may maintain an interference member 36 in place. One or more constrictions 40 may be formed in an initial machining process, casting process, molding process, or the like. Alternatively, or in addition thereto, one or more constrictions 40 may be formed or installed in an assembly process.

For example, in selected embodiments, after an interference member 36 has been placed within a corresponding interference aperture 38, a locking ring may be installed to form a constriction 40 preventing inadvertent removal of the interference member 36 from the interference aperture 38. Alternatively, after an interference member 36 has been placed within an interference aperture 38, a portion (e.g., an opening) of an interference aperture 38 may be swaged or otherwise deformed to form a constriction 40 preventing inadvertent removal of the interference member 36.

An interface mechanism 18 may include a plurality of interference members 36 and corresponding interference apertures 38. In selected embodiments, the number of interface mechanisms 36 may be selected to distribute the loads applied thereby to a corresponding extension 16. Such distribution may lower the stress imposed on the extension 16, interference members 36, base 30, slide 32, and the like. It may also balance such loading. In selected embodiments, three interference members 36, each contained within a corresponding interference aperture 38, uniformly distributed in a circumferential direction about an extension aperture 34 may be sufficient.

An interference member 36 in accordance with the present invention may be biased toward a particular position or configuration. For example, an interface mechanism 36 may be biased (e.g., by a spring or the like) racially inward within a corresponding interference aperture 38. Alternatively, an interface mechanism 36 may be biased racially outward within a corresponding interference aperture 38. In still other embodiments, an interference member 36 may be unbiased and, when not confined by a slide 32, travel relatively freely within a corresponding interference aperture 38.

An interference member 36 in accordance with the present invention may have any suitable shape. For example, an interference member 36 may be spherical. Accordingly, in selected embodiments, one or more interference members 36 may comprise metal balls such as those for ball bearings.

A slide 32 may be configured to travel with respect to a base 30. For example, a slide 32 may be configured to translate in the axial direction with respect to a corresponding base 30. In selected embodiment, a slide 32 may move between one or more blocking positions 42 and one or more non-blocking positions 44. In a blocking position 42, a slide 32 may block an interference member 36 from moving out of engagement with an extension 16 (e.g., out of engagement with a locking groove 28 of an extension 16). Accordingly, when a slide 32 is in a blocking position 42, an interface mechanism 18 may be secured to (e.g., lock onto) a corresponding extension 16.

In a non-blocking position 44, a slide 32 may permit an interference member 36 to move within the corresponding interference aperture 38. Accordingly, with a slide 32 in a non-blocking position 44, an interference member 36 may move out of engagement with an extension 16 (e.g., out of engagement with a locking groove 28 of an extension 16). Accordingly, when a slide 32 is in a non-blocking position 44, an interface mechanism 18 may be easily removed from a corresponding extension 16.

In selected embodiments, an interface mechanism 18 may include a shackle aperture 46. A shackle aperture 46 may extend through a base 30, a slide 32, or some combination thereof. In certain embodiments, a shackle aperture 46 may extend in a radial direction. For example, a shackle aperture 46 may extend diametrically through an interface mechanism 18.

A shackle aperture 46 may perform various functions. For example, a shackle aperture 46 may provide a location for a shackle 26 of a locking mechanism 22 to engage and secure to an interface mechanism 18. A shackle aperture 46 may also enable a shackle 28 to secure a slide 32 with respect to a base 30. For example, a shackle aperture 46 may enable a shackle 28 to lock a slide 32 in a blocking position 42, thereby, enabling a secure connection from an extension 16 to an interface mechanism 18 and from the interface mechanism 18 to a locking mechanism 22.

In certain embodiments, a shackle aperture 46 may comprise multiple portions 46a, 46b. A first portion 46a may comprise a shackle aperture formed within or through a base 30. A second portion 46b may comprise a shackle aperture form within or through a slide 32. When the first and second portions 46a, 46b align, a shackle 28 may be inserted therethrough and restrict relative motion between the base 30 and the slide 32. The first and second portions 46a, 46b may be configured to align when the slide 32 is in a blocking position 42. Accordingly, when inserted through the first and second portions 46a, 46b, a shackle 28 may secure an a slide 32 in a blocking position 42.

A slide 32 in accordance with the present invention may have any suitable shape. In selected embodiments, a slide 32 may include various structures to improve aesthetic appearance, facilitate use, actuation, or manipulation by a user, increase strength or rigidity, or the like or some combination or sub-combination thereof. For example, a slide 32 may include a rib 48 extending circumferentially thereabout. In certain embodiments, such a rib 48 may enable a slide 32 to better handle the stresses associated with maintaining one or more interference members 36 in engagement with a corresponding extension 36.

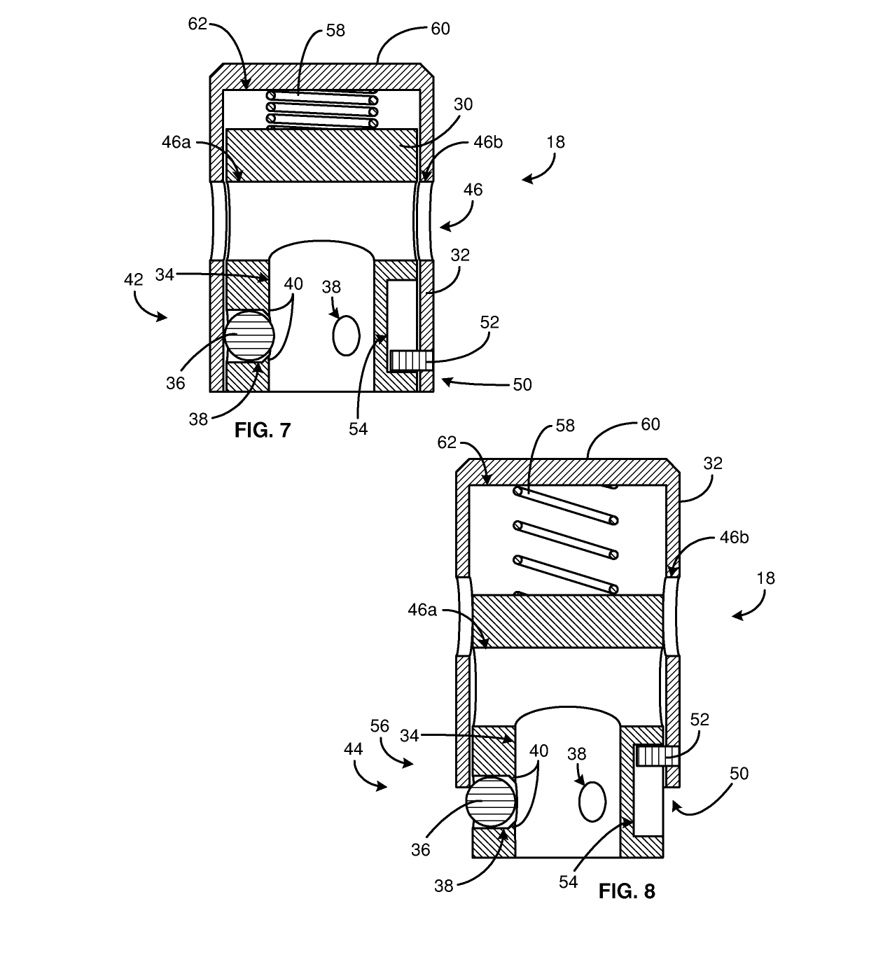

Referring to FIGS. 7 and 8, in certain embodiments, removal of a shackle 28 from a shackle aperture 46 may enable a slide 32 to be completely removed from a corresponding base 30. In other embodiments, it may be desirable to maintain a connection between a slide 32 and base 30 even after a shackle 46 has been removed. Accordingly, in selected embodiments, an interface mechanism 18 in accordance with the present invention may include one or more limiters 50.

A limiter 50 may set one or more limits on the relative motion between a slide 32 and corresponding base 30. In selected embodiments, a limiter 50 may limit rotation of a slide 32 about a base 32, translation of a slide 32 with respect to a base 30, or some combination thereof.

In certain embodiments, a limiter 50 may comprise a rider 52 and a corresponding slot 54. Relative motion between a slide 32 and base 30 may provide relative motion of the rider 52 within the slot 54. Accordingly, the shapes and sizes of the rider 52 and slot 54 may provide limits to the relative motion between the corresponding slide 32 and base 30.

For example, a rider 53 may extending from one of a slide and a base 30. A slot 54 may be formed in the other of the slide 32 and base 32. The slot 54 may have a width and depth enabling the rider 52 to travel therewithin. The slot 54 may have a first end spaced in the axial direction from a second end (e.g., the length of the slot 54 may be aligned with the axial direction). Relative motion of the slide 32 with respect to the base 30 may cause the rider 52 to travel within the slot 54. Contact between a rider 52 and a first end of the slot 54 may define one limit to the axial travel of the slide 32 with respect to the base 30. Alternatively, or in addition thereto, contact between a rider 52 and a second end of the slot 54 may define another limit to the axial travel of the slide 32 with respect to the base 30. Meanwhile, contact between the rider 52 and one or more sides of the slot 54 may limit rotation of a slide 32 about a base 30.

A rider 54 may extend from a base 30 or slide 32 in any suitable manner. For example, a rider 54 may be monolithically formed as part of a base 30 or slide 32. This may be done in an initial machining process, casting process, molding process, or the like. Alternatively, a rider 52 may be formed or installed in an assembly process. For example, a rider 52 may be formed in an assembly process by inserting and securing a pin, bolt, screw, key, or the like into a slot 54, by bending or swaging some material of a base 30 or slide 32 into a slot 54, or the like.

A limiter 50 may prevent inadvertent disassembly an interface mechanism 18. A limiter 50 may also enable a slide 32 to prevent inadvertent removal of one or more interference members 36. For example, a limiter 50 may stop further motion of a slide 32 at a retaining position 56. A retaining position 56 may be a non-blocking position 44 in that, in the retaining position 56, one or more interference members 36 may be free to fully disengage an extension 16. However, a retaining position 56 may still enable a slide 32 to prevent the one or more interference members 36 from falling out of respective interference apertures 38. Accordingly, in embodiments wherein a limiter 50 provides a retaining position 56, certain constrictions 40 of one or more interference apertures 38 may be omitted.

In selected embodiments, an interface mechanism 18 may be biased. For example, an interface mechanism 18 may include one or more biasing members 58 (e.g., springs) biasing the interface mechanism 18 toward a blocking position 42. Alternatively, one or more biasing member may bias an interface mechanism 18 toward a non-blocking position 44.

A biasing member 58 may act on slide 32, base 30, or some combination thereof in any suitable manner. For example, in certain embodiments, a slide 32 may include an end cap 60. An end cap 60 may define a cavity 62. Such a cavity 62 may extend between the end cap 60 of a slide 32 and an adjacent end (e.g., axial end) of a base 30. One or more biasing members 58 may be positioned within a cavity 62.

In selected embodiments, one or more biasing members 58 positioned within a cavity 62 may be pulled (e.g., stretched) as a slide 32 transitions from a blocking position 42 to a non-blocking position 44. Accordingly, in such embodiments, a slide 32 may be biased toward a blocking position 42. Alternatively, one or more biasing members 58 positioned within a cavity 62 may be compressed as a slide 32 transitions from a non-blocking position 44 to a blocking position 42. Accordingly, in such embodiments, a slide 32 may be biased toward a non-blocking position 44.

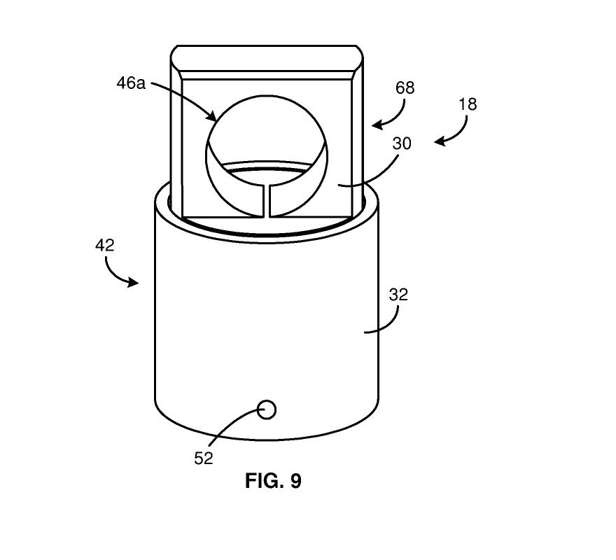

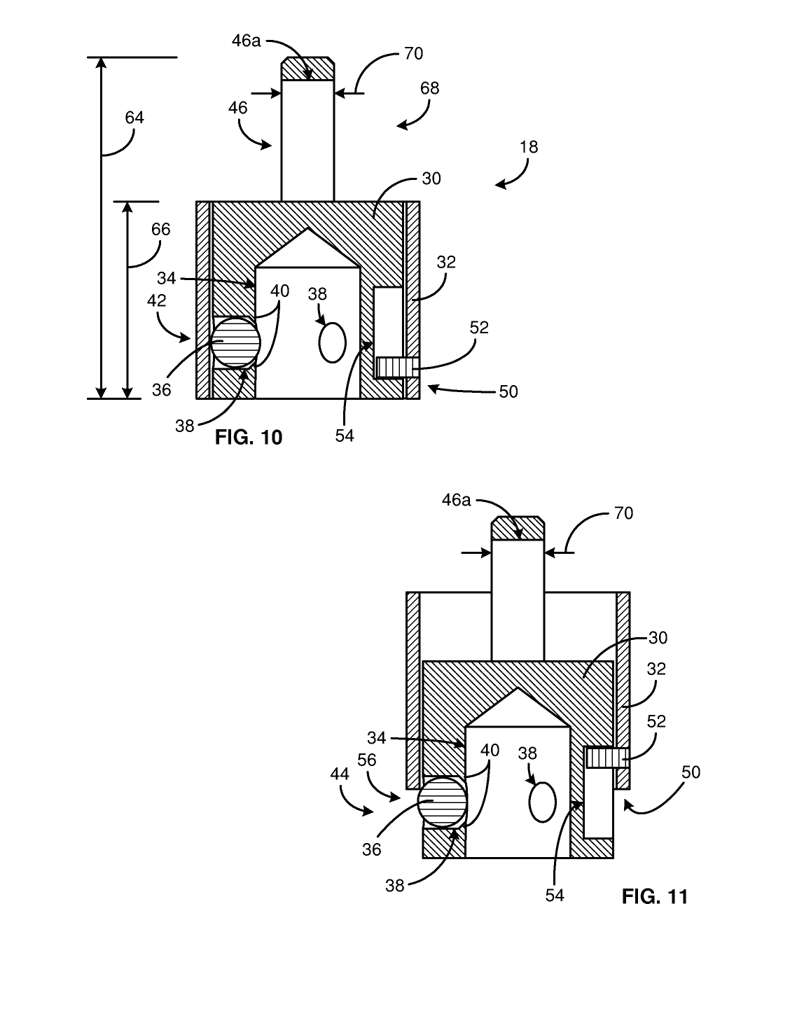

Referring to FIGS. 9-11, in selected embodiments, a shackle 28 may secure a slide 32 in a blocking position 42 without passing through both a base 30 and a slide 32. For example, in certain embodiments, a base 30 may have an length 64 that is longer than the length 66 of a corresponding slide 32. Accordingly, a certain portion 68 of a base 30 may extend past a slide 32. A shackle 28 may extending through an aperture 46a in this portion 68. By extending therethrough, a shackle 28 may abut an adjacent end of a slide 32 and limit certain movements of the slide 32 in the axial direction. The width 70 of an extended portion 68 of a base 30 may be substantially less than the width (e.g., diameter) of the rest of base 30. In selected embodiments, this reduction in width may enable a corresponding shackle aperture 46a to receive shackles 28 of different shapes. For example, the reduction in width may enable the shackle aperture 46a to accommodate a portion of a shackle 28 that is continuously curved.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A system comprising:
an item having an extension extending therefrom;
an interface mechanism connected to the extension, the interface mechanism comprising
a cylindrical base defining axial, radial, and circumferential directions and comprising an extension aperture and a shackle aperture, the extension aperture receiving the extension therewithin,
a cylindrical slide surrounding at least a portion of the cylindrical base; and
a padlock comprising a shackle extending through the shackle aperture, the shackle blocking selected travel in the axial direction of the cylindrical slide with respect to the cylindrical base.

2. The system of claim 1, wherein the extension extends in the axial direction into the first aperture.

3. The system of claim 1, wherein the shackle aperture extends in the radial direction through the cylindrical base.

4. The system of claim 1, wherein the cylindrical base comprises at least one interference aperture and at least one interference member, a first interference member of the at least one interference member being positioned at least partially within a first interference aperture the at least one interference aperture.

5. The system of claim 4, wherein the extension comprises a locking groove extending circumferentially thereabout.

6. The system of claim 5, wherein the first interference member engages the locking groove.

7. The system of claim 6, wherein the cylindrical slide blocks retraction of the first interference member from the locking groove and, thereby, locks the extension within the cylindrical base.

8. The system of claim 7, wherein the first interface mechanism is spherical in shape.

9. The system of claim 8, wherein:
the at least one interference apertures comprises three interference apertures; and
the at least one interference member comprises three interference members.

10. The system of claim 1, wherein the cylindrical slide comprises a shackle aperture.

11. The system of claim 4, wherein:
the shackle aperture of the cylindrical base is in alignment with the shackle aperture of the cylindrical slide; and
the shackle extends through both the shackle aperture of the cylindrical base and the shackle aperture of the cylindrical slide.

12. The system of claim 1, wherein the system further comprises an anchor and a flexible tether extending to tie the padlock to the anchor.

13. A system comprising:
an item having an extension extending therefrom, the extension comprising a locking groove extending circumferentially thereabout;
an interface mechanism connected to the extension, the interface mechanism comprising
a cylindrical base defining axial, radial, and circumferential directions and comprising an extension aperture, a shackle aperture, and an interference aperture, the extension aperture receiving the extension therewithin,
an interference member positioned at least partially within the interference aperture and extending therefrom to engage the locking groove,
a cylindrical slide surrounding at least a portion of the cylindrical base and blocking retraction of the interference member from the locking groove; and
a padlock comprising a shackle extending through the shackle aperture, the shackle blocking selected travel in the axial direction of the cylindrical slide with respect to the cylindrical base.

14. The system of claim 13, wherein the system further comprises an anchor and a flexible tether extending to tie the padlock to the anchor.
